(19) United States
(12) Patent Application Publication
(10) Pub. No.: US 2018/0182048 A1
(43) Pub. Date: Jun. 28, 2018

(54) SUPPLY SYSTEM AND METHOD OF OPERATING A SUPPLY SYSTEM

(71) Applicants: Carsten Stöcker, Hilden (DE); Jürgen Waffner, Essen (DE)

(72) Inventors: Carsten Stöcker, Hilden (DE); Jürgen Waffner, Essen (DE)

(73) Assignee: Innogy Innovation GmbH, Essen (DE)

(21) Appl. No.: 15/901,046

(22) Filed: Feb. 21, 2018

Related U.S. Application Data
(63) Continuation of application No. PCT/EP2016/067991, filed on Jul. 28, 2016.

(30) Foreign Application Priority Data
Aug. 27, 2015 (DE) 10 2015 114 215.5

(51) Int. Cl. G06Q 50/06; H04L 29/08; H04L 9/06

(52) U.S. Cl. CPC G06Q 50/06; G06Q 2220/00; H04L 9/0637; H04L 67/104

(57) ABSTRACT

Embodiments of the invention relate to a system, in particular a supply system, comprising a first entity connectable to at least one physical supply channel network, at least one further entity connectable to the physical supply channel network, at least one peer-to-peer network configured to provide a peer-to-peer application, wherein the first entity comprises at least a further communications device connectable to the peer-to-peer network, wherein the other entity comprises at least one communications device connectable to the peer-to-peer network and wherein at least one of the communications devices is configured at least to cause generation of a supply medium transaction agreement about the physical exchange of a supply medium between the first entity and the further entity by means of the peer-to-peer application.

### CROSS-REFERENCE TO RELATED PATENT APPLICATIONS

This patent application is a continuation of PCT/EP2016/067991, filed Jul. 28, 2016, which claims priority to German Application No. 10 2015 114 215.5, filed Aug. 27, 2015, the entire teachings and disclosure of which are incorporated herein by reference thereto.

### FIELD OF THE INVENTION

The invention relates to a system, in particular a supply system, comprising a first entity connectable to at least one physical supply channel network and at least one further entity connectable to the physical supply channel network. The invention further relates to a method, a communications device and a peer-to-peer application.

### BACKGROUND OF THE INVENTION

Systems for supplying entities with a supply medium are known in the art. Examples of supply systems which are not exhaustive are electrical supply networks, gas supply networks, water supply networks and district heating networks.

All supply systems are characterized in the present application in that at least one supply medium in a supply network is transferred via at least one physical, in particular grid-based, supply channel network. Examples of supply media which are not exhaustive are electrical current or electrical power, water, such as fresh water, waste water or water for irrigation, gaseous media such as natural gas or a similar (combustible) gas, heat, for example in the form of hot air, and cold, for example in the form of cold air.

A physical supply channel network may at least comprise a physical, grid-based supply channel. The at least one physical supply channel network may be an electrical line, preferably a plurality of electrical energy lines, in the case of an electrical supply system such as an electricity network. In addition, with other supply systems such as gas, heat or water supply systems, the physical, in particular grid-based, supply channel network may be formed from at least one fluid line, e.g. in the form of a pipeline, in particular a network of pipelines.

The supply channel network may be, at least in part, a public supply channel network and/or, at least in part, a private supply channel network, such as a separate isolated network.

The at least one physical supply channel network of a supply system may, in particular, connect at least two entities to one another. In an exemplary electrical supply system, at least a first entity comprising at least one electrical consumer may be connected to another entity comprising at least one electrical producer. The consumer can be supplied with electrical power by the producer via a physical channel in the supply channel network.

Common to all prior art supply systems is that, in addition, a central subsystem, a central process and/or a central organization or instance is provided, in order to generate both a supply medium transaction agreement with the first entity and also with the other entity. In other words, the purchase and sale of a supply medium is centrally controlled by a central instance. Trade in the supply medium takes place exclusively via this or possibly a further central instance.

Technically speaking, a corresponding supply system is realized according to the state of the art by a client-server structure. The central organization or instance is created by one or a plurality of central servers. A server of this kind or a platform can be distributed and located on different computing devices, for example. This means that a virtual server can be realized by a cloud. For example, a centrally arranged database can be provided. Examples from the state of the art of databases of this kind which are frequently also referred to as a platform are marketplace databases or cloud platforms, delivery fulfillment databases or cloud platforms or billing systems or cloud services. In particular, a central instance can be configured to order or trade in the supple medium, carry out the billing process, oversee payment and/or manage the portfolio. In particular, the central server in a supply medium transaction agreement is used as a confidential instance for the at least two entities. The central instance, such as a server or a platform, defines the rules. Because these supply medium transaction agreements are performed by the central server, it is ensured that the processes are carried out correctly for all entities involved (consumers, producers, etc.). In other words, a central instance prevents tampering by one of the participating entities and/or by third parties.

Based on the example of an electrical supply network, a typical prior art supply system 100 is described by means of FIG. 1. FIG. 1 shows an exemplary embodiment of a prior art supply system 100. The supply system 100 shown comprises at least one physical supply channel network 102. The physical supply channel network 102 is one or a plurality of electrical lines, for example, such as earth connections and/or overland connections. In addition, a physical supply channel network 102 (not shown) may comprise transformer devices and the like.

A first entity 104 and a further entity 106 are connected to the physical supply channel network 102 via electrical connections 108. A connection 108 may be configured for the bidirectional exchange of current or power. For example, the first entity 104 may be a household 104 which comprises one or a plurality of electrical consumers 110. The first entity 104 may therefore also be referred to as the consumer 104. The consumer 104 can obtain power from the supply systems 100, in particular from the physical supply channel network 102, via the corresponding connection 108.

The further entity 106, for example a household 106, may have in addition to at least one consumer 112 a producer 114 in the form of a photovoltaic device 114, for example. The further entity 106 is therefore producer and consumer. An entity 106 of this kind can be referred to as a prosumer (producer and consumer) 106. The prosumer 106 can obtain power from the supply system 100, in particular from the physical supply channel network 102, via the corresponding connection 108 or feed it into the supply system 100, in particular into the physical supply channel network 102.

In addition, a central server, in particular a central management server 116, may be provided. The central management server 116 is configured to manage the supply system 100. The server 116 can communicate with the at least two entities 104, 106 via communications connections 118, for example internet connections, or by manual data readout. In particular, each entity 104, 106 may have a client device (not shown).

This means that the central management server 116 can, based on a query message from the client device of the first entity 104, generate a supply medium transaction agreement between the management server 116 and the first entity 104 about the exchange, in particular the delivery, of a supply medium quantity for a future period. Moreover, in a corresponding manner, a supply medium transaction agreement can be generated between the management server 116 and the further entity 106 about the exchange, for example the acceptance, of supply medium. The supply medium may then be transferred from the further entity via the physical supply channel network 102 to the first entity 104. In this way, a supply medium transaction agreement has been indirectly generated between the entities 104, 106. Alternatively, by means of the central server 116, a supply medium transaction agreement can be generated between the entities 104, 106. The subsequent billing based on the quantity of supply medium actually exchanged can also be carried out by the central instance 116. For example, the meters of the respective entity 104, 106 can be read out from the server 116, analyzed and then billed according to the analysis.

The disadvantage of server-client structures of this kind, particularly the server (or platform), apart from the high transaction costs, is that the central instance or central server manages customer data. A persistent problem affecting the central instance is that of protecting the customer data stored on one server/a plurality of servers from access by unauthorized third parties. In particular, a high degree of security expenditure is required, in order to prevent customer data, billing data, forecast data, etc. from being tampered with. This in turn leads to higher transaction costs.

Therefore, the object of the invention is to provide a system, a communications device and a method of operating a supply system which simplifies the generation of a supply medium transaction agreement and, at the same time, offers a high level of security.

### BRIEF SUMMARY OF THE INVENTION

The object is solved according to a first aspect of the invention by a system, in particular a supply system, as described herein. The system comprises a first entity connectable to at least one physical supply channel network. The system comprises at least one further entity connectable to the physical supply channel network. The system comprises at least one peer-to-peer network configured to provide a peer-to-peer application. The first entity comprises at least one communications device connectable to the peer-to-peer network. The other entity comprises at least one further communications device connectable to the peer-to-peer network. At least one of the communications devices is configured at least to cause generation of a supply medium transaction agreement about the physical exchange of a supply medium between the first entity and the further entity by means of the peer-to-peer application.

In contrast to the state of the art, a supply medium transaction agreement is easily generated according to the invention between two entities without a central instance, in that instead of a central server or a platform, a peer-to-peer network (also called a framework) undertakes the tamper-proof generation of a supply medium transaction agreement by means of a peer-to-peer application. In the case of a peer-to-peer network, high security standards are achieved in that all computers (peer nodes) in the network, at least a fraction of the peer computers in the network, monitor(s) the accuracy of supply medium transaction agreements. The transaction costs can be significantly reduced. No central, superior platform, server, cloud, etc. is required.

The system according to the invention is characterized by a supply channel network for transferring at least one supply medium between at least two entities connectable to the supply channel network. Examples of systems, particularly supply systems, which are not exhaustive are electrical supply networks, gas supply networks, water supply networks and district heating networks.

Depending on the type of the supply system, electrical current or electrical power, water, such as fresh water, waste water or water for irrigation, gaseous media, such as natural gas or a similar (combustible) gas, heat, for example in the form of hot air, and/or cold, for example in the form of cold air, can be transferred or exchanged as a supply medium via a suitable physical, in particular grid-based, supply channel network.

A supply channel network may be at least in part a public supply channel network and/or at least in part private supply channel network. For example, the network may be a separate microgrid (only) for entities in the supply system or a virtual microgrid. It may preferably be a public network.

In particular, at least a first entity and a further entity can each at least be connected via a suitable connection to the physical supply channel network. The connection corresponds to the physical supply channel network and may be an electrical line or a fluid connection, for example. It shall be understood that a supply system can comprise three or more entities. A supply network in the present case should be particularly understood to mean a supply system in which at least one entity can produce the supply medium and preferably feed it into a line belonging to the physical supply channel network and at least one entity can received the supply medium from the line within the physical supply channel network and preferably consume it. With supply networks of this kind, it is desirable for the quantity fed in and the quantity removed to balance one another out. In particular, a supply channel network in the present case is characterized in that it has limited capacity.

An entity may be configured to exchange a supply medium with at least one further entity via the physical supply channel network. In principle, a supply system may comprise different kinds of entities, provided these can be connected to the physical supply channel network. An entity may, for example, be a building, part of a building, such as an apartment, a single (intelligent) unit or machine, a business or the like.

In order to cause the physical exchange of the supply medium without a central server, platform, etc., at least one of the entities can be configured to cause the generation of a supply medium transaction agreement about the physical exchange of a supply medium by means of the peer-to-peer network. For this purpose, each entity preferably comprises at least one communications device. A communications device may be a computing device such as a computer, a mobile unit, a computing mechanism of another unit such as a television, a television set, etc., or at least part of one of these units. The communications device may be a hardware and/or a software module.

The communications device is configured to communicate with the peer-to-peer network or the computer-computer network. Compared with a client-server network in which a server provides a service and a client uses this service, in a peer-to-peer network this roll allocation is removed. Each participant in the peer-to-peer network can use a service and provide it themselves. In particular, a peer-to-peer network is self-determining and/or self-organized (without a superior unit). In the present case, each computer within the peer-to-peer network preferably has a peer-to-peer application. The communications device may be a node in the peer-to-peer network or simply provide an interface module for communication with the peer-to-peer network.

The peer-to-peer network is configured to provide at least one peer-to-peer application configured to generate at least one supply medium transaction agreement. The peer-to-peer application is characterized in that the peer-to-peer application or the data content of the peer-to-peer application can be accessed and, in particular, controlled by all participants in the peer-to-peer network. It shall be understood that two or more, in particular different, peer-to-peer applications can be provided.

A supply medium transaction agreement may, in particular, include data about the at least two participating entities, for example a unique ID and/or hash code, such as an entity address known to at least all participants of the peer-to-peer network, the quantity of a supply medium to be exchanged, the time period of the exchange and/or at least one transaction criterion. Through suitable checking and/or validation algorithms, such as digital signatures and/or hash functions, the accuracy and/or constancy of a generated supply medium transaction agreement can, in particular, be guaranteed by the cumulative processing power of the computer in the peer-to-peer network.

At least one of the communications devices, preferably all communications devices, is/are configured to cause or initiate generation of a supply medium transaction agreement between two entities, for example by transmitting a message comprising an instruction on the generation of the supply medium transaction agreement. In particular, a suitable code and, where necessary, at least one key for verifying the sender of a message and/or the authenticity of a message can be transmitted to the peer-to-peer application or written in the peer-to-peer application by the communications device. Preferably following a confirmation message from the further entity comprising a suitable instruction and, where necessary, at least one key for verifying the sender of the confirmation message, a corresponding supply medium transaction agreement can be advantageously generated following a check by the peer-to-peer network of the peer-to-peer application. Expressed in simple terms, each entity can search for one or a plurality of suitable partners for the exchange of a supply medium by means of the peer-to-peer network or the peer-to-peer application and a supply medium transaction agreement can be generated by means of the peer-to-peer application.

The list of all participants or entities can preferably be made known to each participant, so in particular to each entity of the supply system, as an identifier, e.g. in the form of a communications address.

Following the generation of a supply medium transaction agreement, the supply medium can be exchanged accordingly between the entities, for example transferred from the first entity to the other entity or from the other entity to the first entity using the physical supply channel network.

According to a first embodiment of the system according to the present invention, the peer-to-peer application may be a decentralized register. The decentralized register can be readable by at least each participant of the peer-to-peer network. In particular, all communications devices and all other computers within the peer-to-peer network can preferably read all information in the peer-to-peer application created as the register. All communications devices and all other computers within the peer-to-peer network can preferably send messages to the peer-to-peer application or write into it. Information can preferably easily be made accessible to all participants. This allows a conduction of a check of the information stored in the decentralized register. In particular, each computer within the peer-to-peer network can preferably be configured to carry out a check of new information, particularly based on older information stored in the peer-to-peer application.

Furthermore, according to a further embodiment of the system according to the invention, each computer or node in the peer-to-peer network may have the peer-to-peer application. Each computer may preferably comprise the entire data content, but at least part of the data content, of the peer-to-peer application, in particular the decentralized register.

It may be provided, for example, that following positive verification of new information written in the peer-to-peer application, this information is stored by all computers, at least by some of the computers. Protection against tampering can thereby be further improved.

In order to store new information in a tamper-proof manner, the peer-to-peer application may include encryption means and/or signature means and/or verification means, for example suitable hash functions. At least one means of the aforementioned means may be configured to store, in particular, at least each supply medium transaction agreement generated. In particular, it may be provided that by means of the hash function a chain with at least one previous piece of information stored in the decentralized register is produced. Further data, such as enquiries, master data, context and/or transaction data of an entity can be stored.

In a particularly preferred embodiment, the peer-to-peer application may be a block chain comprising at least two blocks connected to one another. Block chain technology or decentral ledger technology is already used for payment by means of a cryptocurrency such as bitcoin. It has been recognized that through a special configuration a block chain can be configured to generate at least one supply medium transaction agreement between two entities, particularly in a tamper-proof manner. The block chain according to the present embodiment is, in particular, a decentralized peer-to-peer-based register in which all supply medium transaction agreements and other messages from entities can be logged. A block chain is particularly suitable as a technical means for replacing a central instance in a simple and, at the same time, secure manner.

Moreover, it may be provided according to an embodiment of the system that the communications device is configured to generate at least one query message and/or at least one acceptance message based on a supply medium plan created for the entity of the communications device. A supply medium plan can preferably be created for each entity. A supply medium plan is characterized in the present case in that it comprises an individual forecast in particular for each entity for at least one future period of time in relation to the demand and/or supply of a supply medium. An entity may comprise suitable means or may be connectable to said means, in order to create a supply medium plan. For example, the creation of the supply medium plan may be based on historic data relating to the past demand/supply of a supply medium, (external) forecast data such as weather data and/or user specifications, such as calendar data, an individual's stay (including a forecast of when residents return home and/or when a business starts processing), capacity data relating to a storage such as a battery, etc. The creation of an (optimized) supply medium plan may, in particular, be configured by the entity, preferably a local application for communicating with the at least one peer-to-peer application. For example, in the case of a gas supply system the creation of the supply medium plan may be based on the historic consumption of gas by the entity. In addition, weather forecasts and temperature data, for example, can be taken into account. Similarly, with other kinds of supply systems, a supply medium plan can be created. Based on the supply medium plan, the communications device for the entity may transmit a query message to the peer-to-peer network, in particular to the previously described peer-to-peer application. Each entity or the communications device assigned thereto can preferably read the information transmitted. In one embodiment, a communications device based on a(n) (own) supply medium plan and, in particular, a query message of a further entity can generate an acceptance message and, in particular, transmit it to the peer-to-peer network, such as the previously described peer-to-peer application. A supply medium transaction agreement virtually optimal for at least two entities can easily be prepared by means of the peer-to-peer network and the peer-to-peer application.

In a preferred embodiment, a query message may comprise a supply medium quantity indication, a period of time and/or at least one transaction criterion. A query message may advantageously comprise at least the aforementioned data entries. In addition, a sender identifier, such as a unique address known to each participant in the peer-to-peer network, a time stamp, further transaction criteria, etc. may be included in a query message. Alternatively or in addition, it may be provided that an acceptance message comprises a supply medium quantity indication, a period of time and/or at least one transaction criterion. An acceptance message may preferably have at least the aforementioned data entries and, in particular, a reference to a query message from another entity. Furthermore, an identifier of the sender, such as a unique address known to each participant of the peer-to-peer network, a time stamp, further transaction criteria, etc. may be included, in addition, in an acceptance message.

In order to ensure a correct exchange of a supply medium according to a supply medium transaction agreement generated between two entities, at least one metering device may be provided which is configured to record the quantity of supply medium transferred via a connection of an entity to the physical supply channel network. Each entity may preferably have a corresponding metering device or at least be connectable thereto. A metering device may, in particular, be a smart meter, for example a gas meter, an electricity meter, a flow meter, etc. The quantity of supply medium can preferably be measured over time. This enables the quantity of supply medium transferred, that is fed in or removed, over a given time to be determined. The communications device may be configured to transfer a measured supply medium quantity to the peer-to-peer application. For example, a communications link may be provided between the communications device and the at least one metering device assigned to an entity. The communications device can preferably transmit, depending on a supply medium transaction agreement, the supply medium quantity measured over the period of time specified in the agreement to the peer-to-peer application. The other entity can preferably record the supply medium quantity in a corresponding manner and transmit it to the peer-to-peer application. A check of the information transmitted to the peer-to-peer application, in particular the quantity of supply medium actually supplied and/or received, can then be carried out by the peer-to-peer network, as described above, for example. The correct physical exchange of a supply medium can easily be guaranteed without a central instance. Tampering by an entity or by third parties can be prevented.

The communications device can preferably be configured, depending on a positive check, as previously described, of the quantity of supply medium actually supplied and/or received, to cause the generation of a transaction criterion transaction based at least on a transaction criterion defined in a supply medium transaction agreement and the measured quantity of transaction medium. For example, a given amount, particularly of a cryptocurrency, can be specified as the transaction criterion. If the supply of a supply medium was carried out according to the supply medium transaction agreement, the specified amount can be transferred to the other entity within the framework of a transaction criterion transaction by means of the peer-to-peer network, in particular the peer-to-peer application. In a similar manner to that described above, the unique keys of the entities can also be used for verification for this transaction. The keys and, in particular, the actual possession of the amount by an entity can be checked by the peer-to-peer network, as described above, for example. Secure payment can be made by means of a peer-to-peer network without a central instance. Transaction costs can be further reduced.

In the case of supply channel networks, it may be necessary for secure operation of the supply channel network for the demand and supply of the supply medium to be (virtually) balanced. It may occur, however, that one or a plurality of query messages cannot be fulfilled by entities. For example, it may be that the demand for a supply medium by an entity cannot be met by the other entities. It may also be that the entities cannot consume the supply medium quantity provided by another entity. This means that critical network states can occur in the supply channel networks. Consequently, in order to guarantee a secure and stable operation of a supply system, according to a further embodiment the supply system can be configured a balancing entity to cause the generation of the respective supply medium transaction agreements with all entities for which the query message is unfulfilled, by means of the peer-to-peer application. In other words, the balancing entity may be configured to fulfil the supply medium demand and accept the offer of the supply medium. A balancing entity may be a supply medium company, such as a gas supply company, an energy supply company, etc. By providing a balancing entity in a supply system, it is possible to ensure that the demand for and supply of the supply medium can be (virtually) balanced. Furthermore, the balancing entity of the peers can report and sell unused flexibility to the network operator or other market participants outside the peer-to-peer network. The purchaser of the flexibility can then control this directly via the control channel or via the balancing entity.

It may also occur that an actual demand for or an actual supply of a supply medium with an entity can differ from the previously created supply medium plan. An entity, particularly a computing device such as the communications device, may preferably be configured to make a preferably routine check of whether the supply medium quantities agreed by the entity for future time periods in supply medium transaction agreements can actually be provided and or accepted. For example, the check can be carried out at a predetermined point in time before the period of time specified in a supply medium transaction agreement and/or during the actual exchange of the supply medium, for example by comparing the actual exchange quantity that can be measured with the specified exchange quantity.

In the event that a deviation from the entity is detected, the communications device may preferably cause generation of a further supply medium transaction agreement about the deviation detected with another entity and/or with an entity outside the peer-to-peer network.

A further aspect of the invention is a method of operating a system, in particular a previously described system. The system comprises a first entity connectable to at least one physical supply channel network, at least a further entity connectable to the physical supply channel network and at least one peer-to-peer network configured to provide a peer-to-peer application. The method comprises:
causing generation of at least one supply medium transaction agreement about the physical exchange of a supply medium between the first entity and the other entity by means of the peer-to-peer application.

A further aspect is a communications device for a first entity connectable to at least one physical supply channel network comprising:
at least one communications module configured to communicate with a peer-to-peer network providing a peer-to-peer application
   and
wherein the communications module is configured to cause generation of a supply medium transaction agreement about the physical exchange of a supply medium between the first entity and a further entity by means of the peer-to-peer application is configured.

Each entity of a previously described system may preferably comprise a communications device of this kind. The communications device may be formed at least in part from hardware and/or software.

A further aspect of the invention is a method of operating a communications device for a first entity connectable to at least one physical supply channel network involving:
causing generation of a supply medium transaction agreement about the physical exchange of a supply medium between the first entity and a further entity by means of the peer-to-peer application.

The method may, in particular, be used to operate the previously described communications device.

Yet a further aspect of the invention is a computer programs with instructions that can be executed on a processor in such a manner that a communications device is operated according to the previously described method.

A further aspect is a peer-to-peer application comprising:
means for receiving at least one message from a communications device of a first entity connectable to a physical supply channel network, wherein the message from the first entity means that the generation of a supply medium transaction agreement about the physical exchange of a supply medium between the first entity and a further entity can be caused and
means of generating the supply medium transaction agreement upon receipt of the message.

The peer-to-peer application can, in particular, be used in a previously described system and/or controlled by a previously described communications device. The peer-to-peer application may be created at least in part from hardware and/or software. In particular, the peer-to-peer application according to the invention may be based on block chain technology.

A further aspect of the invention is a method of operating a peer-to-peer application comprising:
receiving of at least one message from a communications device of a first entity connectable to a physical network, wherein the message from the first entity means that the generation of a supply medium transaction agreement about the physical exchange of a supply medium can be caused between the first entity and a further entity and
generation of the supply medium transaction agreement upon receipt of the message.

The method may, in particular, be provided to operate the previously described peer-to-peer application.

Yet a further aspect of the invention is a computer program with instructions that can be executed on a processor in such a manner that a peer-to-peer application is operated according to the previously described method.

The features of the methods, systems or networks, devices and computer programs can be freely combined with one another. In particular, features of the description and/or the dependent claims, even when the features of the dependent claims are completely or partially avoided, may be independently inventive in isolation or freely combinable with one another.

There is a plurality of possibilities for the configuration and development of the methods according to the invention, the systems according to the invention, the device according to the invention and the computer programs according to the invention. In this respect, reference is made firstly to the patent claims subordinate to the independent patent claims and secondly to the description of exemplary embodiments in conjunction with the drawing.

### BRIEF DESCRIPTION OF THE SEVERAL VIEWS OF THE DRAWING

In the drawing:

FIG. 1 shows a schematic view of an exemplary embodiment of a supply system according to the state of the art;

FIG. 2 shows a schematic view of an exemplary embodiment of a system according to the present invention;

FIG. 3 shows a schematic view of an exemplary embodiment of an entity according to the present invention comprising an exemplary communications device according to the present invention;

FIG. 4 shows a schematic view of an exemplary embodiment of a peer-to-peer application according to the present invention;

FIG. 5 shows a schematic view of a further exemplary embodiment of a system according to the present invention;

FIG. 6 shows a schematic view of a further exemplary embodiment of a system according to the present invention;

FIG. 7 shows a diagram of an exemplary embodiment of a method according to the present invention;

FIG. 8 shows a diagram of a further exemplary embodiment of a method according to the present invention;

FIG. 9 shows a diagram of a further exemplary embodiment of a method according to the present invention; and

FIG. 10 shows a diagram of a further exemplary embodiment of a method according to the present invention.

### DETAILED DESCRIPTION OF THE INVENTION

In the figures, the same reference numbers are used for the same elements.

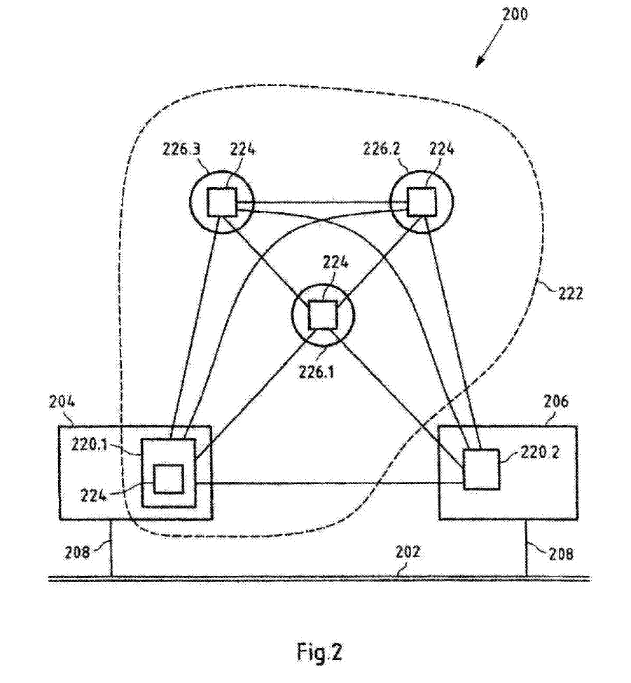

FIG. 2 shows a schematic view of an exemplary embodiment of a system 200, in particular a supply system 200, according to the present invention. The supply system 200 may be an electrical supply network, a gas supply network, a water supply network or a district heating network.

The present system 200 comprises by way of example a first entity 204 and a further entity 206. It shall be understood that more than two entities 204, 206 can be provided. An entity 204, 206 may be a building, a household, a plant or machine, an electronic unit, etc.

In addition, as can be seen, each entity 204, 206 comprises at least one connection 208 configured to connect the entity 204, 206 to a supply channel network 202. The connection 208 may be disconnectable, for example by a switch, a valve, etc. The type of supply channel network 202 depends on the type of supply system 200. In a gas supply network 200 the network 202 may be a pipeline network 202 for gas, for example. Correspondingly suitable connections 208 may be provided for an electricity network, a water network of a district heating network. It shall be understood that an entity may be part of more than one supply system 200.

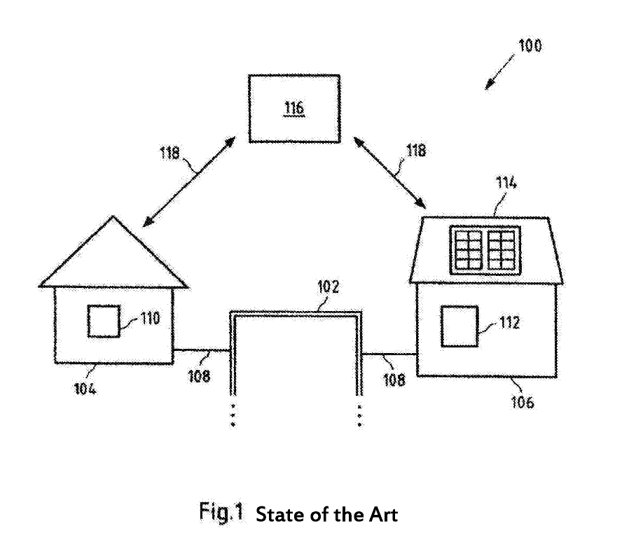

A substantial difference compared with a prior art system, such as system 100 according to FIG. 1, is that no central instance is provided. In the present case, the system 200 has a peer-to-peer network 222 or a computer-computer network 222. The peer-to-peer network 222 comprises a plurality of nodes 226.1 to 226.3 or computers 226.1 to 226.3. A peer-to-peer network 222 is characterized in the present case in that each node and/or participant is preferably connected to every other node and/or participant. In addition, the computers have equal rights, something which distinguishes them from a server-client structure.

The three depicted nodes 226.1 to 226.3, for example computer 226.1 to 226.3, (each) comprise a peer-to-peer application 224. As can be seen, the same peer-to-peer application 224 is implemented on each node 226.1 to 226.3. The peer-to-peer application 224 may preferably be a public register 224 that can, in particular, be inspected by all participants (not only the node) of the peer-to-peer network 222. Each node 226.1 to 226.3 preferably has the (entire) public register 224. It may also be envisaged that only part of the register is provided on a node. In a particularly preferred embodiment, the peer-to-peer application 224 may be a block chain 224.

In addition, it can be seen that in the present case each entity 204, 206 has a communications device 220.1, 220.2. A communications device 220.1, 220.2 is configured to communicate at least with the peer-to-peer network 222, i.e. the nodes of the 226.1 to 226.3. In other words, the communications device 220.1, 220.2 or the entity 204, 206 corresponding to this communications device 220.1, 220.2 is at least a participant of the peer-to-peer network 222. In this case, all participants of the peer-to-peer network 222 are preferably known to each participant of the peer-to-peer network 222.

In the present case, the first communications device 220.1 is a node or computer in the peer-to-peer network 222. Hence, the communications device 220.1 likewise comprises the peer-to-peer application 224. In the present case, a supply medium transaction agreement about the exchange of a supply medium between the entities 204, 206 can be generated by means of the peer-to-peer application 24 in a tamper-proof manner. For this purpose, each communications device can communicate with the peer-to-peer application 224, in order to cause the generation of a supply medium transaction agreement. The supply medium, such as electrical current or electrical power, water, such as fresh or waste water, gaseous media such as natural gas or a similar (combustible) gas, heat, for example in the shape of hot air, and/or cold, for example in the form of cold air, can then be transferred according to the generated agreement.

An exemplary embodiment of a peer-to-peer application according to the invention is explained in greater detail below in the same way as the mode of operation of the system.

The exemplary embodiments below relate to an improved demonstration of a supply system in the form of an electrical power network. The invention is not limited to this, however. In particular, the following embodiments can be translated to other supply systems or networks, such as gas supply networks, water supply networks or district heating networks.

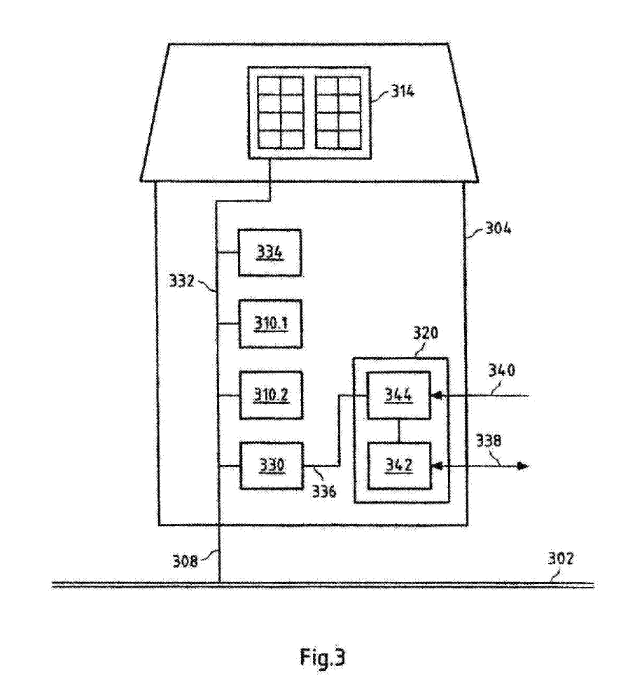

FIG. 3 shows a schematic view of an exemplary embodiment of an entity 304 according to the present invention, wherein the entity 304 comprises an exemplary embodiment of a communications device 320 according to the present invention.

The entity 304 may be a building 304 or household 304. The entity 304 can be connected to a supply channel network 302 via a connection 308. The supply channel network 302 may be an electrical current network 302 comprising electrical energy lines, transformers, etc.

Moreover, in the present exemplary embodiment, an internal power circuit 332 of the entity 304 is connected via the connection 308 to the public or private electricity network 302.

By way of example, two electrical consumers 310.1, 310.2 are connected to the electrical circuit 332. Examples of electrical consumers 310.1, 310.2 which are not exhaustive are refrigerators, lighting systems, televisions, computers, washing machines, kitchen appliances, etc. It shall be understood that an entity 304 can comprise more than two electrical consumers 310.1, 310.2.

Apart from the electrical consumers 310.1, 310.2, the entity 304 in the present case comprises an electrical producer 314 in the form of a photovoltaic device 314. It shall be understood that, alternatively or additionally, other electrical producers such as a micro-wind turbine, CHP (combined heat and power), etc. can be provided. The power supplied by the producer 314 may be consumed by the consumers 310.1, 310.2, (temporarily) stored in an electrical energy storage 334 such as a battery and/or fed into the electricity network 302.

Moreover, in the present case a metering device 330 is connected to the electrical circuit 332. The metering device 330 may comprise a meter, in order to determine the amount of power obtained from the electricity network 302 and the amount of power fed into the electricity network 302. In one embodiment, the metering device 330 may comprise at least two meters. The two meters may be assembled in a common housing or form separate units. It shall be understood that more than two meters can also be provided.

The advantage of two meters is particularly that, on the one hand, the entity 304 can generate a (basic) supply medium transaction agreement with a central instance such as a central server of a network operator and, on the other hand, it can generate individual supply medium transaction agreements with other entities by means of the peer-to-peer network. In order to be able to clearly assign a supply medium transaction agreement to the respective power flow or current flow, a meter can record the total quantity, for example, and the at least one further meter can record the quantity/quantities that flow during periods of time in which individual supply medium transaction agreements have been concluded. A clear assignment of a supplied or received and measured quantity of power can then be determined by computing operations to the different supply medium transaction agreements.

It shall be understood that further metering devices can be provided, in order to determine individually the consumption of individual consumers or the power supplied by a producer, for example.

The entity 304 further comprises a communications device 320. The communications device 320 may, for example, be at least part of a computing device, such as a computer. In particular, the communications device may be formed at least in part from a software module and/or at least in part from a hardware module.

The communications device 320 has, in particular, a communications module 342, in order to communicate (bidirectionally) with the peer-to-peer network via a communications link 338. In addition, a communications device 320 may have a processing module 344 connectable to the communications module 342. The processing module 344 may at least be configured to generate peer-to-peer application-compatible messages. In addition, the processing module 344 may have at least one data input. For example, an internal communications connection 336 to the metering device 330 may be provided. In addition, data from external data sources, such as weather data sources, etc., can be received by the processing module 344 via a communications network 340 and, in particular, processed. The communications device may also comprise further interfaces to other installations. In particular, user interfaces such as a display and/or input means can be provided. A detailed description of the mode of operation of the communications device 320 is given below.

In addition, it should be pointed out that in an advantageous embodiment data, such as weather forecasts and/or market data, can be made available to each peer by a so called feed from the peer-to-peer application. For example, the participants may have agreed on one or a plurality of weather data suppliers. In this case, the at least one weather data source may transmit the weather forecast data to the peer-to-peer application. The weather source may have been validated by at least part of the peer. The same weather data are then preferably made available by means of the peer-to-peer application to each peer. It shall be understood that a supply medium plan for an entity can be created based on other weather data.

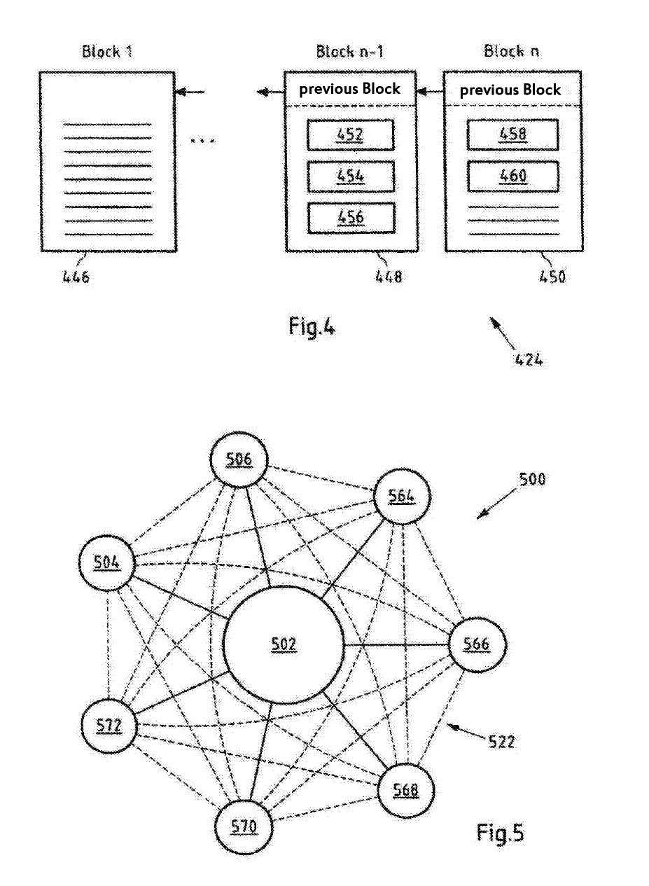

FIG. 4 shows a schematic view of an exemplary embodiment of a peer-to-peer application 424 according to the present invention. The peer-to-peer application 424 is, in particular, a register that can be inspected/visible by participants of a peer-to-peer network 424, in which messages can be written and/or read out by entities or participants of the peer-to-peer network. In a preferred exemplary embodiment, the peer-to-peer application 424 may be a block chain 424.

In the more detailed description of the present exemplary embodiment below, it is assumed that the peer-to-peer application 424 is a block chain 424. However, the following embodiments can easily be translated to other peer-to-peer applications.

The block chain 424 is formed from at least one block 446 to 450, preferably a plurality of blocks 446 to 450 connected to one another. The first block 446 may also be referred to as the genesis block 446. As can be seen, a block 448, 450 (except for the first block) relates to the preceding block 446, 448 in each case. A new block may be created by a computing-intensive process (by mining or a corresponding process, for example) and, in particular, provided to all participants in the peer-to-peer network.

The present block chain 424 is particularly configured to receive messages from a communications device of a participant in the peer-to-peer network and to store this message in the block chain 424. Based on the embodiment of a block chain 424 as a public register 424, the message from a communications device can preferably be read by all participants in the peer-to-peer network.

In the present block chain 424, different kinds of messages can be processed and/or stored within a smart contract (algorithm and/or store on the block chain), for example. The message 452 may be a query message 452, for example. A query message is characterized in that it comprises the following data:

Indication of amount: the amount of supply medium which is required by an entity or made available to it
Time indication: future period of time in which the supply amount indicated is required or made available
Transaction criterion: criterion which must be met by the other entity, in order to conclude a supply medium transaction agreement for the indicated amount and period of time

It shall be understood that other transaction criteria can be defined. Other indications may be, for example, a time stamp, a signature from the message sender, a message ID and other transaction criteria, such as an indication of the desired kind of production or consumption, distance from the entity, etc.

A further message 454 may be an acceptance message 454. An acceptance message may have the same or at least similar data as a query message. In addition, the acceptance message 454 may comprise a reference to the preceding query, such as the ID of the query message. For example, it may be listed in an acceptance message in relation to a query message that a given and desired quantity of supply medium can be supplied for the future period of time based on the transaction criterion. The quantity may be a partial quantity of the quantity required. The time indication may be a partial time indication. Likewise, a lower/higher transaction criterion may be specified.

If an acceptance message comprises only a partial quantity of the required quantity, a partial time indication and/or a smaller/higher/other transaction criterion, the acceptance message may be referred to as a counter-offer message. This may be accepted by the first entity by an acceptance message. Based on this, the entity may cause the generation of a supply medium transaction agreement.

In particular, there may be a plurality of query messages and/or acceptance messages. Each entity may provide specifications according to which at least one supply medium transaction agreement can be generated. In a preferably automatic, for example iterative, process, each query message can be assigned the most optimally corresponding query message. The block chain 424 may, in addition, be configured, based on the messages and with the involvement of the entities, to generate a supply medium transaction agreement 456.

A supply medium transaction agreement 456 may be stored in a block 448 within a smart contract 456. A smart contract may comprise a computer program code. In the supply medium transaction agreement, the exchange and supply or receipt of a given quantity of the supply medium for a given period of time and/or a transaction criterion, such as a given price, may be agreed between the first entity and a further entity. For example, the first entity may cause with the further entity by means of the block chain the generation of an agreement that the first entity supplies the further entity for a period of time Tₓ and an amount X with a given quantity of electrical power (X kW/h) via the electricity network. Corresponding supply medium transaction agreements can be generated in other supply systems.

In addition, a transaction criterion transaction 458, such as the transaction of a previously agreed amount of a cryptocurrency following fulfillment of the supply medium transaction agreement, can be stored in a block 450. For this purpose, the corresponding meter data 460 of the entities which the supply medium transaction agreement had concluded may also be stored in the block chain 424, in order, in particular, to carry out verification through the peer-to-peer network as to whether the quantity of supply medium has been supplied and received according to the agreement. The meter data are, in particular, supply medium quantities which have actually been measured by a metering device of an entity during the specified period of time.

In particular, the peer-to-peer application 424 is configured to store the stored messages in a tamper-proof manner. This essentially involves a supply medium transaction agreement being able to be verified throughout the entire peer-to-peer network through the cumulative processing power of the entire peer-to-peer network, for example.

At least the previously described messages, such as the supply medium transaction agreements, can preferably be hashed together in pairs in a block of the block chain through a Merkle tree. In particular, only the last hash value, also called root hash, can be noted as the checksum in the header of a block. The block can then be chained to the previous block. The chaining of the blocks can be carried out with the help of this root hash. Each block may include in the header the hash of the entire preceding block header. This enables the sequence of blocks to be clearly specified. Moreover, the subsequent modification of preceding blocks or of the messages stored in the preceding blocks can thereby be (practically) excluded, as the hashes of all subsequent blocks, in particular, would likewise have to be recalculated within a short time.

FIG. 5 depicts a schematic view of a further exemplary embodiment of a system 500, in particular an electrical supply system 500. The supply system 500 depicted in a greatly simplified form comprises seven entities 504, 506, 564 to 572 in the present case. All entities 504, 506, 564 to 572 can at least be connected to a supply channel network 502, in particular an electricity network 502.

As can further be seen, the entities 504, 506, 564 to 572 or the respective communications devices thereof (not shown) create a peer-to-peer network 522 which provides a peer-to-peer application (not shown), e.g. the block chain 424 according to FIG. 4.

The first entity 504 may be a household 504 which comprises a plurality of electrical consumers. The first entity 504 may therefore also be referred to as the electrical consumer 504. The first entity 504 therefore has a demand for the supply medium and can generate corresponding query and/or acceptance messages and also transmit them to the peer-to-peer network 522. The further entity 506 may likewise be a household 506, in particular a prosumer 506. As the prosumer 506, the other entity can deliver power to the electricity network 502 and also receive power from the electricity network 502. The prosumer may generate corresponding query and/or acceptance messages and transmit them to the peer-to-peer network 522.

The further entity 564 may be a decentralized producer 564, such as a wind turbine 564. In other words, the entity 564 is configured to feed power into the electricity network 502. It may generate corresponding messages and also the following entities may generate corresponding messages. Moreover, an electrical storage 566, such as a battery 566, may be present as the entity 566. The storage 566 may be particularly configured, due to overcapacity in the electricity network 502, to store the overcapacity temporarily and deliver it again when there is a demand for power. In addition, an entity 568 may be an electrically operated machine 568, so, for example, a (smart) electrical consumer 568, such as a IoT device. The entity 570 may be a business 570, for example, with a plurality of electrical consumers and/or with one or a plurality of producers. Finally, a balancing entity 572 is provided as the entity 572, which is explained in greater detail below.

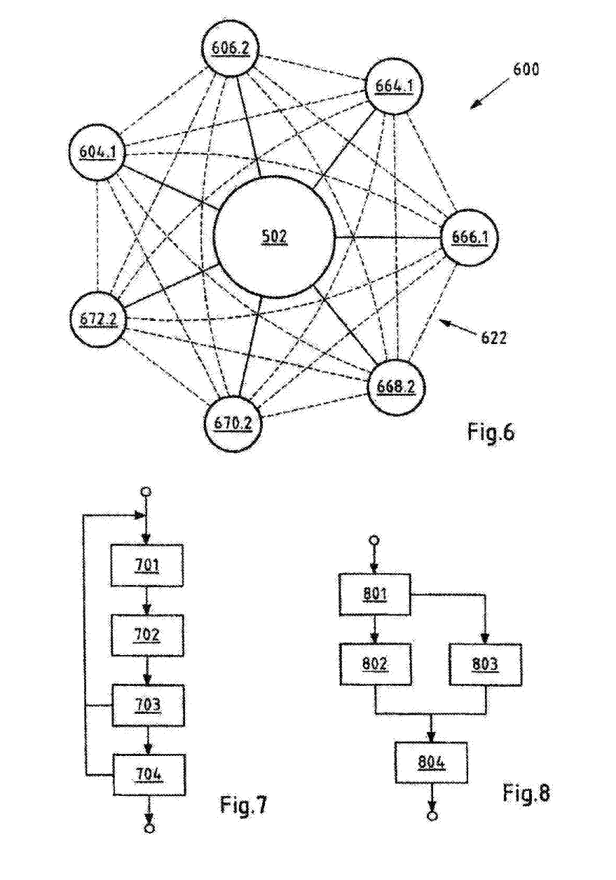

FIG. 6 shows a schematic view of a further exemplary embodiment of a system 600, in particular an electrical supply system 600. Only the differences compared with a supply system, such as the one depicted by way of example in FIG. 5, are described below. It should be pointed out that the entities 604.1 to 672.2 may be the same, similar or different entities as/to/from the previously described entities.

Unlike in the previous example, in the present case two different kinds of peers or node computers 604.1, 664.1, 666.1 or 606.2, 668.2, 670.2 and 672.2 are depicted. All peers 604.1 to 672.2 are included in the peer-to-peer network 622. In the present exemplary embodiment, however, only some of the peers 604.1 to 672.2, in the present case peers 604.1, 664.1, 666.1, check the validity of the messages stored in the peer-to-peer application, such as supply medium transaction agreements. It may also be provided that only some of the peers store the entire peer-to-peer application and/or only some of the peers execute the algorithms of the smart contracts. Since validation can involve a substantial amount of computational work, it may be advantageous for efficiency reasons for only some of the peers 604.1, 664.1, 666.1, in particular particularly powerful peers 604.1, 664.1, 666.1, to perform the validation. “Powerful” refers in particular to high processing power. In other words, in the present case a valid entry in the peer-to-peer application, such as a block chain, is assumed, if (only) some of the peers 604.1, 664.1, 666.1 have achieved a positive outcome. It goes without saying that a single peer, in particular an especially powerful peer, can also perform the validation alone.

Likewise, it may be provided in an alternative embodiment (not shown) that a particularly large peer-to-peer network can be divided into two or more clusters. With a corresponding peer-to-peer network, validation can only be carried out by the members of a cluster, for example.

The modes of operation of different components of exemplary systems according to the invention are explained in greater detail below by means of FIGS. 7 to 10.

FIG. 7 shows a flow chart of a method which can be performed in particular by a peer-to-peer application, such as the block chain 424 according to FIG. 4.

In a first step 701, the peer-to-peer application receives a message relating to the exchange of a supply medium from an entity. Examples of messages which are not exhaustive are query or acceptance messages, supply medium transaction agreements, metering data messages, transaction criterion transaction messages, etc. These are subsequently checked for plausibility by at least some of the peers in a peer-to-peer network, as has just been explained, for example.

In a next step 702, the received message is stored by the peer-to-peer application. Due to the special configuration of the peer-to-peer application and the peer-to-peer network each participant can, in particular, read the message. The peer-to-peer network can then be verified by the cumulative processing power of the entire peer-to-peer network (step 703). In the event that further messages can be written in the block, the process continues with step 701. In the event that no further messages can be written in the block, step 704 is started. In step 704, the messages in a block, such as the supply medium transaction agreements, can be hashed together in pairs by a Merkle tree, as described above. The process can then continue with step 701.

FIG. 8 shows a further flow diagram of a first exemplary embodiment of a method which can be particularly carried out by an entity or a communications device of an entity.

In a first step 801, a supply medium plan of the entity can be provided for a future period of time. For example, the communications device may create a corresponding supply medium plan or receive this from another device of the entity, such as a home automation control of a home automation system of the entity.

The creation of a supply medium plan may be based on historical data, user inputs and/or forecast data, such as weather data, market data, personal data and calendar data. For example, the current parameters measured can be transmitted by one or a plurality of current meters via communications connections to the communications device. The communications device, as well as the processing device thereof, may be configured to store the received current parameters in a storage device. The transmitted parameters may, in particular, be provided with a time stamp. For example, the consumption and/or producer parameters measured can be provided with a date and/or time. In this way, the profile of the energy consumption/production can be reproduced for previous periods of time. This profile can then be used to create the supply medium plan.

In particular, the supply medium plan can be prepared from this historical data and preferably additional forecast data, such as weather data and/or user data, such as times of absence, for a future period of time, such as the following week, the following day, the following hour, etc. A supply medium plan can preferably be created on the previous day in each case for the following day which can be divided into a plurality of sub-periods (e.g. 15-min intervals, in other words 96 sub-periods).

In addition to the supply medium plan, at least one transaction criterion may be specified for each sub-period. For example, two or more transaction criteria may be specified per sub-period, which criteria may fall between a maximum criterion and a minimum criterion, such as a maximum price and a minimum price. The advantage of specifying a period is that it is possible to react flexibly and at the same time optimally to the query messages from the other entity. The best possible offer from the point of view of the entity based on the independently set criteria may, in particular, be determined and selected in an automatic, iterative process. A preferred producer type, local proximity to the entity, etc. may also be specified as the transaction criterion, for example.

Depending on the aforementioned parameters, a query message, preferably for each sub-period, can be generated by a communications device and transmitted to the peer-to-peer network in step 802. Alternatively or in addition, the entity or the communications device thereof can detect/read query messages from other entities in the peer-to-peer application and, based on the aforementioned parameters and also the parameters of the read message, send acceptance messages to the peer-to-peer network.

In one step 804, the generation of a supply medium transaction agreement with a further entity can be caused by the entity by means of the peer-to-peer application, in particular by agreement with another entity. A corresponding message can preferably be transmitted to the peer-to-peer network by at least one of the entities.

In order to verify messages, public and/or private keys of entities can be used.

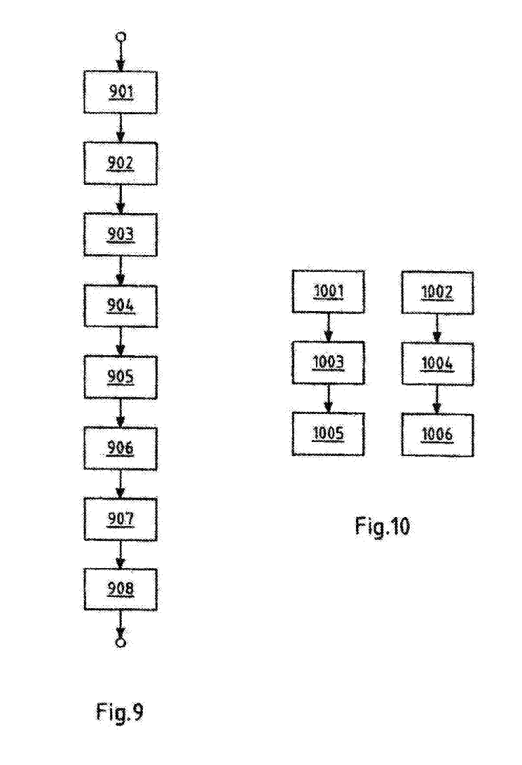

FIG. 9 shows a further diagram of another method according to the present invention. The following method is described by way of example with the help of the supply system 500 according to FIG. 5.

In one step 901, the entities 504, 506, 564 to 570 can preferably each create a supply medium plan and associated transaction criteria. This may take place according to the above explanation.

In one step 902, the generation of a supply medium transaction agreement can then be caused by at least one entity. This may, in particular, be preceded by the exchange of query and acceptance messages from the entities. In particular, a plurality of individual supply medium transaction agreements can be generated between the entities 504, 506, 564 to 570 by means of the peer-to-peer application and the exchange of messages with the peer-to-peer application. It may be that after step 902, queries from entities 504, 506, 564 to 570 could not be fulfilled. For example, with at least one entity in one sub-period or a plurality of sub-periods, there may be a demand for the supply medium. Alternatively or in addition, with at least one entity in one sub-period or a plurality of (other) sub-periods, there may be an excess of generated supply medium. This may occur in the case of volatile producers, for example, such as wind turbines or photovoltaic systems.

In one step 903, it may therefore be provided that the at least one entity 504, 506, 564 to 570 which still has open at least one query message which is at least partially incomplete generates or concludes a supply medium transaction agreement with the balancing entity 572 by means of the peer-to-peer application. A balancing entity 572 may, in particular, be configured to balance a missing supply medium quantity at any time and/or to take a surplus supply medium quantity. For example, the balancing identity 572 may be a supply company, such as an energy supply company. Alternatively and preferably, it may be a decentralized autonomous organization (DAO). In the present exemplary embodiment it may be an electrical energy supply company with a plurality of conventional power stations, for example, and the possibility of passing on energy to entities which are not part of the peer-to-peer network. The balancing entity 572 therefore ensures, in particular, a secure, stable operation of the electricity network. Critical network states can be prevented. The capacity of the electricity network can be used more optimally. Flexibilities can be more effectively utilized.

As has already been described, the supply medium transaction agreements can preferably be concluded on the previous day for the following day. In a step 904, each entity 504, 506, 564 to 570 can preferably execute a new check at a later point in time of their own forecasts, in other words of the supply medium plan, in particular of individual sub-periods. For example, it may be provided that at least one individually determinable point in time before a sub-period, each entity 504, 506, 564 to 570 preferably checks to see whether the planned demand/supply for the sub-period is actually being achieved. It shall be understood that following generation of a supply medium transaction agreement, a virtually continuous check can be conducted until the agreed starting time.

If a deviation is detected between the planned supply medium quantity and the currently forecast supply medium quantity for a particular sub-period, for example due to weather changes and/or user actions, the entity 504, 506, 564 to 570 may generate a further supply medium transaction agreement with a further entity 504, 506, 564 to 570 by means of the peer-to-peer application in step 905. This occurs particularly due to the detected deviation. If, for example, a producer and a consumer detect corresponding deviations, these entities may cause the generation of a corresponding supply medium transaction agreement. The security of supply and/or network stability can thereby be guaranteed decentrally and, in particular, the use of decentralized systems and the network can be optimized decentrally.

It should be pointed out in this case that due to the configuration of the peer-to-peer application according to the invention, such as a block chain, a subsequent change in a supply medium transaction agreement may not be possible, but a further supply medium transaction agreement must be generated if it is established that a previous supply medium transaction agreement can be fulfilled at least incompletely.

In the event that in step 905 queries from entities 504, 506, 564 to 570 could not be fulfilled, supply medium transaction agreement(s) can be generated in step 906 according to step 903.

In the next step 907, each entity 504, 506, 564 to 570 can preferably check (continuously) during the respective sub-period specified in a supply medium transaction agreement whether the (currently measured) actual values of the supply medium agree with the supply medium quantity specified in the supply medium transaction agreement. If a deviation is identified, for example due to weather and/or market changes and/or user actions, this deviation may be balanced in step 908 by (direct) generation of supply medium transaction agreements with other entities which have also detected a current deviation and/or directly balanced by the balancing entity 572. A secure and stable operation of a supply network can be achieved decentrally.

FIG. 10 shows a further exemplary embodiment of a method according to the present invention. In particular, the method may be implemented when the exchange of the supply medium according to a supply medium transaction agreement has already taken place.

In a first step 1001, an energy quantity received during the time period Tx can be supplied to a first entity, in particular the communications device of the first entity. The energy quantity can preferably be supplied by a metering device. The metering device can measure the electrical power (X kW/h) obtained from the electricity network, at least during the period of time Tx. Preferably parallel to this, in a step 1002 an energy quantity supplied during the time period Tx may be provided to a further entity, in particular the communications device of the further entity. For example, this also takes place by means of a metering device, as previously described.

In steps 1003 and 1004, it can be checked by means of the peer-to-peer application in each case whether the supply medium quantity has been exchanged in accordance with the supply medium transaction agreement between the first and the further entity. For example, the measured energy quantities supplied can be sent by the respective entity to the peer-to-peer application. The entire peer-to-peer network can then perform the check.

Depending on the result of the check, the first entity may remit all (or only part) of the agreed price in the form of cryptocurrency in step 1005. In step 1006, the other entity receives the remitted cryptocurrency. Steps 1005 and 1006 are also carried out according to the previous explanation by the peer-to-peer application in a particularly tamper-proof manner. In particular, a previously described plausibility check can be carried out by at least some of the peers.

The entire peer-to-peer network can preferably check by means of cumulative processing power whether the energy quantities are correct and/or the remittance has been correctly carried out; so, for example, the first entity was actually the holder of the cryptocurrency.

It may also be provided that a network operator announces the actually measured meter values subsequently, for example once a month, week, etc., based on the meter data and makes an adjustment from this to the supply medium quantity actually exchanged in respect of the quantities measured in the peer-to-peer application. This adjustment may also be offset by means of the peer-to-peer application and, for example, between the entities.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system, in particular a supply system, comprising:
a first entity connectable to at least one physical supply channel network;
at least one further entity connectable to the physical supply channel network;
at least one peer-to-peer network configured to provide a peer-to-peer application;
wherein the first entity comprises at least a further communications device connectable to the peer-to-peer network;
wherein the other entity comprises at least one communications device connectable to the peer-to-peer network; and
wherein at least one of the communications devices is configured at least to cause generation of a supply medium transaction agreement about the physical exchange of a supply medium between the first entity and the further entity by means of the peer-to-peer application by sending a message, comprising instructions for generating a supply medium transaction agreement;
wherein at least one of the communications devices is configured to generate at least one query message, comprising a supply medium quantity indication, a period of time and/or at least one transaction criterion, and/or at least one acceptance message, comprising a supply medium quantity indication, a period of time and/or at least one transaction criterion, based on a supply medium plan created for the respective entity of the communications device.

2. The system according to claim 1, wherein
the peer-to-peer application is a decentralized register; and
the decentralized register is readable by at least some of the participants of the peer-to-peer network.

3. The system according to claim 1, wherein each computer in the peer-to-peer network comprises the peer-to-peer application.

4. The system according to claim 1, wherein the peer-to-peer application comprises encryption means and/or signature means and/or verification means, wherein at least one means of the encryption means and/or signature means and/or verification means is configured to store at least each supply medium transaction agreement generated.

5. The system according to claim 1, wherein the peer-to-peer application is a block chain comprising at least two blocks connected to one another.

6. The system according to claim 1, wherein
at least one metering device may be provided which is configured to record the quantity of supply medium transferred via a connection of an entity to the physical supply channel network; and
the communications device is configured to transmit a measured supply medium quantity to the peer-to-peer application.

7. The system according to claim 6, wherein the communications device is configured to cause generation of a transaction criterion transaction based on at least one transaction criterion specified in a supply medium transaction agreement and the measured supply medium quantity.

8. A method of operating a system, in particular a system according to claim 1, wherein the system comprises a first entity connectable to at least one physical supply channel network, at least a further entity connectable to the physical supply channel network and at least one peer-to-peer network configured to provide a peer-to-peer application, comprising:
causing generation of at least one supply medium transaction agreement about the physical exchange of a supply medium between the first entity and the other entity by means of the peer-to-peer application by sending a message, comprising instructions for generating a supply medium transaction agreement;
wherein at least one query message, comprising a supply medium quantity indication, a period of time and/or at least one transaction criterion, and/or at least one acceptance message, comprising a supply medium quantity indication, a period of time and/or at least one transaction criterion, is generated based on a supply medium plan created for at least one of the entities of the communications device.

9. A communications device for a first entity connectable to at least one physical supply channel network, comprising:
at least one communications module configured to communicate with a peer-to-peer network providing a peer-to-peer application; and
wherein the communications module is configured to cause generation of a supply medium transaction agreement about the physical ex-change of a supply medium between the first entity and a further entity by means of the peer-to-peer application by sending a message, comprising instructions for generating a supply medium transaction agreement;
wherein the communications device is configured to generate at least one query message, comprising a supply medium quantity indication, a period of time and/or at least one transaction criterion, and/or at least one acceptance message, comprising a supply medium quantity indication, a period of time and/or at least one transaction criterion, based on a supply medium plan created for the entity of the communications device.

10. A method of operating a communications device for a first entity connectable to at least one physical supply channel network involving:
causing generation of a supply medium transaction agreement about the physical exchange of a supply medium between the first entity and a further entity by means of a peer-to-peer application by sending a message, comprising instructions for generating a supply medium transaction agreement;
generating at least one query message, comprising a supply medium quantity indication, a period of time and/or at least one transaction criterion, and/or at least one acceptance message, comprising a supply medium quantity indication, a period of time and/or at least one transaction criterion, based on a supply medium plan created for the entity of the communications device.

11. A peer-to-peer application, comprising:
means for receiving at least one message, comprising instructions for generating a supply medium transaction agreement, from a communications device of a first entity connectable to a physical supply channel network, wherein the message from the first entity can cause the generation of a supply medium transaction agreement about the physical exchange of a supply medium between the first entity and a further entity; and
means of generating the supply medium transaction agreement upon receipt of the message;
wherein at least one query message, comprising a supply medium quantity indication, a period of time and/or at least one transaction criterion, and/or at least one acceptance message, comprising a supply medium quantity indication, a period of time and/or at least one transaction criterion, based on a supply medium plan created for the entity of the communications device, is received.

12. A method of operating a peer-to-peer application, comprising:
receiving of at least one message, comprising instructions for generating a supply medium transaction agreement, from a communications device of a first entity connectable to a physical network, wherein the message from the first entity can cause the generation of a supply medium transaction agreement about the physical exchange of a supply medium between the first entity and a further entity; and
generating of the supply medium transaction agreement upon receipt of the message;
wherein at least one query message, comprising a supply medium quantity indication, a period of time and/or at least one transaction criterion, and/or at least one acceptance message, comprising a supply medium quantity indication, a period of time and/or at least one transaction criterion, based on a supply medium plan created for the entity of the communications device is received.
